(19) United States
(12) Patent Application Publication
(10) Pub. No.: US 2014/0103634 A1
(43) Pub. Date: Apr. 17, 2014

(54) STRUCTURED COLOR FILTER DEVICE

(71) Applicant: OPSEC SECURITY GROUP, INC., Denver, CO (US)

(72) Inventors: LILY O'BOYLE, Cream Ridge, NJ (US); David Shemo, Langhorne, PA (US)

(73) Assignee: OPSEC SECURITY GROUP, INC., Denver, CO (US)

(21) Appl. No.: 14/054,158

(22) Filed: Oct. 15, 2013

Related U.S. Application Data
(60) Provisional application No. 61/713,993, filed on Oct. 15, 2012.

(51) Int. Cl. G02B 5/22; B42D 15/00; G02B 5/18

(52) U.S. Cl. CPC G02B 5/22; G02B 5/18; B42D 15/00
USPC 283/85; 359/569; 29/592

(57) ABSTRACT

A structured color filtering device includes one or more unit cells. Each unit cell includes a substrate having a surface with a step function surface profile having two or more discrete levels formed therein. The step function surface profile forms in the surface a plurality of grooves arranged in a fundamentally symmetric pattern having a periodic groove pitch. When ordinary light is incident on the surface, the surface is structured to diffract light having a predetermined wavelength toward observation points at all polar angles above the surface greater than a predetermined incident angle.

### CROSS-REFERENCE TO RELATED APPLICATION

This patent application claims the priority benefit under 35 U.S.C. 119(c) of U.S. Provisional Application No. 61/713,993 filed on Oct. 15, 2012, and entitled, “RADIALLY SYMMETRIC STRUCTURED COLOR FILTERING DEVICE,” the contents of which are hereby incorporated herein by reference.

### BACKGROUND

1. Field

The disclosed concept relates generally to optically variable devices (OVDs) and, more particularly, to OVDs using relief structures to create diffractive optical effects. Yet more particularly, the disclosed concept relates to OVDs used for the authentication and anti-counterfeiting protection of various high-value articles, documents, and certificates of authenticity. The disclosed concept also relates to security devices that comprise such OVDs, articles that employ such security devices, and methods for creating such OVDs and security devices.

The disclosed optical color filter device is a surface relief compounded structure.

2. Description of Related Art

An optically variable device (OVD) is a visual device that creates a change or shift in appearance, such as, for example and without limitation, a change in color, when observed from different relative observation points or when the illuminating light changes to a different angle of incidence. The evolution of the OVD as a security device stems largely from the search for a mechanism to resist counterfeiting of certain articles and products, or alternatively to render such copying obvious. For example, and without limitation, paper money, banknotes, certificates, tax stamps, security labels, product hang tags, drivers' licenses, ID cards, and credit cards, among other things, frequently employ one or more OVDs to resist counterfeiting or to verify authenticity.

A counterfeiting deterrent employed in some OVDs involves the use of one or more diffractive images that exhibit optical effects which cannot be reproduced using traditional printing and/or photocopying processes. Such images may be, for example, volume holograms or diffractive grating structures (also known as surface relief holograms). When an OVD including such an image is viewed from a predetermined location and tilted so that it is viewed from a different relative location, an optical effect results, such as, for example and without limitation, movement of the image or a change in color. This effect can serve as the basis of a useful security device.

A high demand for optical overt security features not only created a hologram market but also generated an equipment market associated with making them, ranging from origination systems to foil manufacturing machines. As a result, simulations and counterfeits of lookalike holograms have emerged and now challenge the position of holograms as the leading optical security device. Holograms are capable of having many forensic features embedded within, and their authenticity can be affirmed at different levels with various types of inspection equipment. However, their weak color and high reflectivity mean that the security feature is not easily discernable by the general public.

Accordingly, non-holographic security mechanisms having image-related optical effects have evolved over time. For example, several non-holographic surface relief features have been introduced, such as blazed gratings, asymmetric gratings, depth-dependent gratings, and zero order devices (high spatial frequency gratings that do not diffract at the first order or higher). Many of these features are discussed in Optical Document Security by R. van Renesse (Chapter 6, “Diffraction-based Security Features”). These features cannot be produced by using laser interference recording techniques; they are instead made using e-beam systems and/or nanofabrication equipment and techniques borrowed from the integrated circuit industry.

Notwithstanding these developments, however, the continuous introduction of additional unique effects is needed to stay ahead of the counterfeiters' ability to access or simulate new imaging technologies. Thus, there is still a need for an OVD that provides an easily discernible optical feature, but which is difficult for a counterfeiter to duplicate or simulate.

It is an object of the present disclosure, therefore, to satisfy this need by providing an OVD that provides strong, stable, and easily discernible color effects.

It is a further object of the present disclosure to satisfy this need by providing an OVD that is more difficult to copy or simulate than the prior art, and thus to provide a security device with a higher level of security.

It is a further object of the present disclosure to provide security devices which incorporate such OVDs.

It is a further object of the present disclosure to provide articles, such as goods or documents of value, which incorporate such security devices and OVDs.

It is a further object of the present disclosure to provide methods of manufacturing such security devices.

### SUMMARY OF THE INVENTION

These needs and others are met by embodiments of the disclosed concept, which provides a structured color filtering device comprising a substrate having a step function surface profile formed therein, wherein the step function comprises two or more discrete levels, the step function grooves are arranged in a fundamentally symmetric pattern having a periodic groove pitch, and the surface provides an optical reflection of a predetermined wavelength when light is incident on at least one side of the surface. These embodiments also provide a security device that comprises such a structured color filtering device, an article that employs such a security device, and a method for creating such a security device.

In one embodiment of the disclosed concept, the disclosed device exhibits an interference filtering effect offering distinctive color that is different from a hologram. Typical holograms are first order diffraction devices that produce all colors of the visible spectrum (i.e., “rainbow color”). The disclosed device is made up of one or more unit cells structured with grooves having a step function profile which provides reflective levels at predetermined depths. These grooves are arranged in a specific symmetric groove pattern, for example and without limitation, concentric circles. The cells are preferably in the shape of a convex polygon, for example and without limitation, a triangle, square or regular hexagon, and preferably in the range of 1 micron to 250 microns across. The distance between reflective levels within the grooves preferably ranges from 100 to 2,000 nanometers. In the case of a groove having only two levels, this distance is the groove depth—the first level is the surface of the substrate and the second level is the bottom of the groove.

The symmetric pattern of concentric circles diffracts light evenly in all directions. Such design is made intentionally to increase the ease of viewing with an isotropic appearance that is not dependent on the viewing orientation. In this respect, the behavior of the disclosed device is similar to the behavior of color-shifting pigments. However, even though the novel structure pattern diffracts light evenly in all directions, if the illumination and viewing angles change (by, for example, tilting the device) the optical effect will change as the interference condition changes.

In another embodiment, the disclosed concept comprises a structure-based color filtering device having a compounded secondary structure on a first diffractive structure. The secondary structure is a finer modulating surface compared with the first diffractive structure. The secondary structure is a substructure of the first step function structure within the cell pattern. The substructure has a pitch resolution that is less than half of the primary step function, and the depth is substantially shallower than the primary grooves of the cell structure. The secondary structure can be square-wave or sinusoidal.

In another embodiment, the disclosed concept provides two or more structure-based color filtering devices adjacent to each other or interspersed within each other, each device exhibiting a different color. Such arrangement may be used, for example, to display characters, a pattern or an image. For example, an improved effective first-level authentication means may be constructed by incorporating a first structured color filtering device exhibiting particular codes, characters or shapes in a first color, with a second color device exhibiting a second contrasting color in an adjacent (background) area. The second color device may be another structured color filter device, another OVD (such as a hologram) or a non-OVD (such as printed ink).

It is known that when light at given wavelength λ (i.e., monochromatic light) illuminates a reflective multi-level square wave surface relief, and the reflected light is composed of waves that are out of phase by one-half of one wavelength (the optical path depth of the square groove having an odd multiple of λ/4), then destructive interference occurs and no spectral reflection is observed at wavelength λ. Further, when such a surface is illuminated with white light (i.e., polychromatic light), the light at wavelengths other than the given wavelength λ are reflected at some non-zero intensity, and it is the combination of those reflected wavelengths which is observed in the specular reflection.

In the case where the reflected light from the reflective multi-level square wave surface is composed of waves that are in phase and the depth of the groove is an even multiple of λ/4, constructive interference occurs and maximum reflection is observed for wavelength λ.

Diffracted light is the compliment of specular reflection. Therefore, when the square wave surface is illuminated with polychromatic light, the diffracted light is minimized at the given wavelength λ corresponding to the constructive interference condition and maximized at the wavelength corresponding to the destructive interference condition. Such specular reflection (i.e., the mirror reflection) can be very strong and unpleasant to view, and thus is not ideal in a security device.

When a multi-level square wave structure comprises structures that are straight and linearly aligned in one direction, the first order diffraction of the structure exhibits a visible color, but the color is visually unpleasant because of bright spectral reflection and glare, and is difficult to view because such structures produce the effect in only a narrow angle of view. It is desirable to have a diffractive optical color image device which avoids these two problems.

The disclosed concept comprises a structure producing diffuse reflection and diffraction that is optimized for human viewing—it produces homogeneous color within a wide angle of view in ordinary ambient lighting conditions while minimizing harsh specular reflection. The device comprises an OVD capable of producing any predetermined color via a filtering effect and an improved structure that provides better distributed diffraction with the intended color.

The disclosed device comprises an improved diffractive optical color image device that employs a multi-level square step structure arranged in a symmetric pattern. This pattern and structure provides a visible color effect having a well-distributed direction for any arbitrary orientation of a light source and viewing, and exhibits the intended color in a steady, stable and well-controlled manner.

As the angle of light incident on the device changes, the interference condition changes and therefore the observed color of the diffracted and reflected light changes. This optically variable effect is not exhibited by printed or photocopied duplications. Thus, the disclosed device can form the basis for a useful security device.

In accordance with aspects of the disclosed concept, a structured color filtering device comprises: one or more unit cells, each unit cell comprising: a substrate having a surface with a step function surface profile having two or more discrete levels formed therein, wherein the step function surface profile forms in the surface a plurality of grooves arranged in a fundamentally symmetric pattern having a periodic groove pitch, wherein when ordinary light is incident on the surface, the surface is structured to diffract light having a predetermined wavelength toward observation points at all polar angles above the surface greater than a predetermined incident angle.

Each unit cell may include outer edges that form a convex polygon.

Apothems of the convex polygon may be within a range of about 0.5 micrometers to about 100 micrometers (i.e., the unit cells may have a cell size within a range of about 1 micrometer to about 200 micrometers).

The convex polygon may be one of an equilateral triangle, a square and a regular hexagon.

A distance between two of the two or more discrete levels of the step function surface profile may be within a range of about 100 nanometers to about 2,000 nanometers.

The step function surface profile may be bi-level or multi-level (i.e., more than two discrete levels).

The periodic groove pitch may be within a range of about 0.5 micrometers to about 10 micrometers.

Each of the two or more discrete levels of the step function surface profile has a surface area, and the surface areas of each of the two or more discrete levels of the step function surface profile may be approximately equal.

Two or more of the unit cells may be arranged to form a tessellation.

The substrate may be comprised of a dielectric material or a metal.

The structured color filtering device may include one or more second unit cells, each unit second cell comprising: a second substrate having a second surface with a second step function surface profile having two or more discrete levels formed therein, wherein the second step function surface profile forms in the second surface a plurality of second grooves arranged in a fundamentally symmetric pattern having a second periodic groove pitch, wherein when ordinary light is incident on the second surface, the second surface is structured to diffract light having a second predetermined wavelength toward observation points at all polar angles above the second surface greater than a second predetermined incident angle.

The step function surface profile may form in the surface a secondary plurality of grooves arranged in a fundamentally symmetric pattern having a secondary periodic groove pitch, and wherein the secondary periodic groove pitch of the secondary plurality of grooves is substantially smaller than the periodic groove pitch of the plurality of grooves and/or a depth of the secondary plurality of grooves is substantially smaller than a depth of the plurality of grooves.

The grooves may have sidewalls having randomly varying slopes and widths.

The one or more unit cells may together form recognizable text, symbols or codes.

The structured color filtering device may include a continuous or non-continuous reflective layer disposed upon the substrate.

The structured color filtering device may include a material disposed in the grooves, wherein a refractive index of the material disposed in the grooves is different than a refractive index of the substrate.

The substrate may be transparent and have a first side and a second side opposite the first side, wherein the light having the predetermined wavelength is visible from observation points at all polar angles above the first side of the substrate greater than the predetermined incident angle, and wherein the light having the predetermined wavelength is visible from observation points at all same polar angles with respect to the second side of the substrate greater than the predetermined incident angle.

In accordance with other aspects of the disclosed concept, a security device comprises: at least one structured color filtering device, the at least one structured color filtering device including: one or more unit cells, each unit cell comprising: a substrate having a surface with a step function surface profile having two or more discrete levels formed therein, wherein the step function surface profile forms in the surface a plurality of grooves arranged in a fundamentally symmetric pattern having a periodic groove pitch, wherein when ordinary light is incident on the surface, the surface is structured to diffract light having a predetermined wavelength toward observation points at all polar angles above the surface greater than a predetermined incident angle.

The security device may include a second structured color filtering device disposed adjacent to the at least one structured color filtering device, the second structured color filter device including: one or more second unit cells, each second unit cell comprising: a second substrate having a second surface with a second step function surface profile having two or more discrete levels formed therein, wherein the second step function surface profile forms in the second surface a plurality of second grooves arranged in a fundamentally symmetric pattern having a second periodic groove pitch, wherein when ordinary light is incident on the second surface, the second surface is structured to diffract light having a second predetermined wavelength toward observation points at all polar angles above the second surface greater than a second predetermined incident angle.

The security device may include a hologram device disposed adjacent to the at least one structured color filtering device.

The at least one structured color filtering device may include a plurality of structured color filtering devices, and where the plurality of structured color filtering devices together form at least one of a graphical image, a pattern and a design.

In accordance with other aspects of the disclosed concept, an article comprises: a security device including at least one structured color filtering device, the at least one structured color filtering device including: one or more unit cells, each unit cell comprising: a substrate having a surface with a step function surface profile having two or more discrete levels formed therein, wherein the step function surface profile forms in the surface a plurality of grooves arranged in a fundamentally symmetric pattern having a periodic groove pitch, wherein when ordinary light is incident on the surface, the surface is structured to diffract light having a predetermined wavelength toward observation points at all polar angles above surface greater than a predetermined incident angle.

In accordance with other aspects of the disclosed concept, a method of creating a security device comprises: providing a substrate having a structured color filtering device disposed on a surface thereof, wherein the structured color filtering device comprises one or more unit cells, each unit cell having: a substrate having a surface with a step function surface profile having two or more discrete levels formed therein, wherein the step function surface profile forms in the surface a plurality of grooves arranged in a fundamentally symmetric pattern having a periodic groove pitch, wherein when ordinary light is incident on the surface, the surface is structured to diffract light having a predetermined wavelength toward observation points at all polar angles above the surface greater than a predetermined incident angle.

Each unit cell may include outer edges that form a convex polygon, and wherein apothems of the convex polygon are within a range of about 0.5 micrometers to about 100 micrometers.

A distance between two of the two or more discrete levels of the step function surface profile may be within a range of about 100 nanometers to about 2,000 nanometers.

The periodic groove pitch may be within a range of about 0.5 micrometers to about 10 micrometers.

### BRIEF DESCRIPTION OF THE DRAWINGS

FIG. 1A is a perspective view of a unit cell of an color filter device in accordance with an embodiment of the disclosed concept;

FIG. 1B is a sectional view of the color filter device of FIG. 1A;

FIG. 2 is a view of a color filter device in accordance with another embodiment of the disclosed concept;

FIG. 3 is a view of a color filter device in accordance with another embodiment of the disclosed concept;

FIG. 4 is a view of a color filter device in accordance with another embodiment of the disclosed concept;

FIG. 5 is a view of a security device in accordance with an embodiment of the disclosed concept;

FIG. 6 is a flow diagram illustrating the steps of a method of making a security device in accordance with an embodiment of the disclosed concept;

FIG. 7A is a simplified and exaggerated view of an article employing a security device in accordance with an embodiment of the disclosed concept;

FIG. 7B is a simplified and exaggerated view of an article employing a security device in accordance with another embodiment of the disclosed concept;

FIG. 7C is a simplified and exaggerated view of an article employing a security device in accordance with another embodiment of the disclosed concept; and

FIG. 7D is a simplified and exaggerated view of an article employing a security device in accordance with another embodiment of the disclosed concept.

### DESCRIPTION OF THE PREFERRED EMBODIMENTS

As employed herein, the term “optically variable device” (OVD) is used in its conventional broad sense and includes devices comprising a single optical element alone or multiple optical elements arranged so that they may or may not be touching each other, overlapping, or physically in close proximity to each other.

A “security device” as employed herein, refers to any known or suitable device which employs one or more OVDs in order to verify the authenticity of the article on which the security device is disposed, and to deter and resist copying or counterfeiting of the article.

As employed herein, the term “article” refers to an item or product on which the exemplary structured color filtering device, or an OVD comprising the exemplary filtering device, is employed, and expressly includes, without limitation, articles used in high-security, banking, identification, and brand protection markets, such as, for example, identification cards, credit cards, debit cards, smart cards, organization membership cards, security system cards, security entry permits, banknotes, checks, fiscal tax stamps, passport laminates, legal documents, packaging labels and other information-providing articles wherein it may be desirable to validate the authenticity of the article and/or to resist alteration, tampering or reproduction thereof.

As employed herein, the term “ordinary light” refers to light that includes components from substantially all wavelengths of the visible spectrum. Some examples of ordinary light are sunlight and light emitted from light bulbs such as incandescent light bulbs or fluorescent light bulbs.

As employed herein, the term “light having a predetermined wavelength” refers to light whose components are substantially comprised from a single wavelength of the visible spectrum. The light having a predetermined wavelength may include components having other wavelengths as well so long as they are in insubstantial amounts. The light having a predetermined wavelength will appear as the color corresponding to the predetermined wavelength.

For simplicity of illustration, the example structured color filtering devices shown in the figures and described herein in accordance with the concept are shown in simplified and exaggerated form. Specifically, in order to more clearly show the features or components, elements, layers, and overall structure of the devices, certain features of the devices, such as the dimensions of various structures, have been illustrated in exaggerated form, and are therefore not to scale.

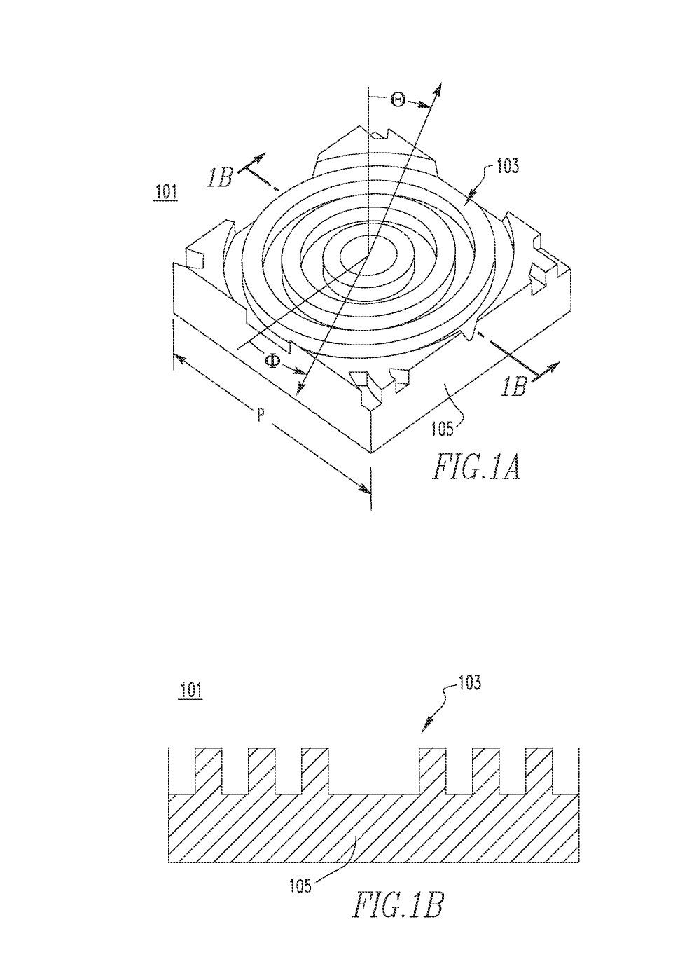

The disclosed structured color filtering device comprises at least one unit cell which includes a diffractive groove having a particular cross-sectional shape and which is arranged in a particular pattern. The pattern (e.g. without limitation, a ring or wave structure) is symmetric about an axis passing through the center of the unit cell. A beam of ordinary light normally incident on a surface containing such a structure is diffracted with equal intensity into all rays directed from the surface. That is, an individual observing the device from any polar angle above the surface greater than a predetermined incident angle would see the same intensity of light having a predetermined wavelength (i.e., a color) from any azimuthal direction. Light having a different predetermined wavelength is observed at polar angles less than the predetermined incident angle. The detailed structure of the rings or waves determines the color variations as the observer changes his polar angular view and/or as the mean angle of incidence changes. In an embodiment of the disclosed concept shown in FIG. 1A, this structure is formed as concentric rings having a periodic multi-level step function.

FIG. 1A shows an embodiment of the disclosed filter device 101 comprising a single unit cell. A diffractive structure 103 is formed in the surface of a substrate 105 (e.g., without limitation, a step function surface profile formed in the surface of the substrate 105). The diffractive structure 103 comprises annular grooves symmetric around an axis passing through a central point of the unit cell. The grooves shown in FIG. 1A are circular, but the disclosure is not thereby limited; diffractive structures comprising ovals, parabolas, waves and other curved shapes may also be effectively employed.

When ordinary light is incident on the surface of the filter device 101, the surface of the filter device 101 is structured to diffract light having a predetermined wavelength toward all observation points at all same polar angles θ above the surface greater than a predetermined incident angle. That is, an observer of the filter device 101 will observe a particular color (i.e., light having a predetermined wavelength) at all azimuthal angles Φ and all polar angles θ above the surface greater than the predetermined incident angle when ordinary light is incident on the surface of the filter device 101. Changing the polar angle θ of the observer's viewpoint will not change the color viewed by the observer unless the polar angle θ of the observer's viewpoint crosses the predetermined incident angle.

The unit cell need not be square, as is shown in FIG. 1A, but outer edges of the unit cell may form a convex polygon such as a rectangle, trapezoid, triangle, or hexagon. Outer edges of the unit cell may also form any other convenient shape. A width P of a unit cell is preferably between about 1 micrometer and about 200 micrometers.

The shape of unit cells is preferably a convex polygon, especially one that may be perfectly tessellated. A plurality of unit cells may be arranged as tiles across a surface to form an area exhibiting a particular color. A fine structure is imparted to the angular diffraction when the ring pattern, or any other pattern which may be used, is repeated across the surface. In some embodiments of the disclosed concept, apothems of the convex polygon are within a range of about 0.5 micrometers to about 100 micrometers.

The groove shape of the diffractive structure 103 conforms to a two-level step function, also called a square-wave function. Both terms mean that the sides of the grooves are sufficiently straight, parallel and at right angles to the surface of the device to enable the grooves to selectively filter a color of light. To achieve the highest efficiency of the optical effect, the reflection from each of the two levels should be equal. Where the reflective efficiencies of the two levels are equal, then the areas occupied by each of the two levels should be equal. In embodiments comprising more than two levels, the area of each level should be equal to the areas of the other levels.

The groove shape of the embodiment of FIG. 1A is shown in FIG. 1B. FIG. 1B is a sectional view of the device of FIG. 1A cut along line 1B. The diffractive structure 103 comprises two-level step function grooves. The step function profile has a groove pitch ranging preferably from about 0.5 to about 10 micrometers. The grooves have uniform depth. The distance between the reflective levels (in this case of a two-level structure, the groove depth) controls the wavelength, and therefore the color, of the light exhibited by the filter device 101. The inter-level distance (the groove depth) is preferably between 100 and 2,000 nanometers. In laboratory tests of a two-level structure, the apparent colors at various groove depths were observed as follows:

TABLE 1

| Groove Depth, nm | Observed Color |
|---|---|
| 180 | yellow |
| 240 | orange |
| 260 | reddish-purple |
| 280 | bluish-purple |
| 330 | blue |
| 380 | yellowish-green |
| 440 | yellow |
| 480 | orange |

The results reported in Table 1 were formed from a structured filter device similar to that shown in FIGS. 1A and 1B, where the unit cells were tiled to form a rectangular array area. The grooves were formed in a polymeric resin base and vacuum coated with aluminum. The grooves were open and filled with ambient air. The light was ordinary light.

It should be noted that because the groove pitch of the disclosed device is preferably >2λ (where the wavelength λ is in the visible spectrum of 400 to 700 nm for example) multiple non-zero diffraction orders will be created. Further, because the unit cell pitch P is much greater than λ, a secondary diffraction pattern having a multitude of non-zero orders is created. These non-zero orders create an observed blending effect between the diffractive bands due to angular dispersion.

Looking again at FIG. 1B, one can see that the grooves are empty (i.e., they are filled with air, which has a refractive index of 1). Filling the grooves with a material having a different refractive index will change the interference condition and therefore the color of the specular and diffuse diffracted reflection. Filling the grooves with a material having the same refractive index as the substrate will of course effectively “erase” the grooves and their optical effects. Application of such a material is a useful method of erasing the optical effect in a particular area, as part of a particular pattern or design, for example.

The substrate 105 is a reflective material such as, for example and without limitation, a dielectric material such as polymer or glass, or a metal. Preferably the substrate 105 is a highly reflective plastic resin film such as polyethylene, polyimide, OPP, PET film, or any other suitable material. Laboratory testing suggests that the best results are obtained with a substrate formed from a polymeric resin base having a refractive index ranging from 1.3 to 1.7. Alternatively, the diffractive structure 103 may be formed in a non-reflective substrate 105, and the structure 103 subsequently coated with a continuous or non-continuous reflective layer (not shown).

A variety of useful diffraction patterns and special effects may be created using the devices and processes herein disclosed. Certain characteristics are inherent in the devices. For example, the finer the groove structure, the greater will be the diffracted angle. The surface reflectivity and the index of refraction differential will affect the strength of the diffraction components. In the embodiment shown in FIGS. 1A and 1B, the annular grooves are formed as a two-level step function structure where the area occupied at each of the two levels is equal. Equalizing the area of each of the two levels minimizes the specular reflection, at least for some illumination wavelengths. However, more complex two- or three-level structures may be useful for some applications, thus allowing for very complex and secure diffraction patterns and effects.

Further, a dithering of the widths of the annular rings so that each ring width is slightly different from its neighbors will cause a broadening of the diffraction angle distribution, an effect which can be useful and which may enable additional security features. The same effect results from an irregular circular profile, either from a non-constant radial sweep or a modified ring wall. Polygons (for example pentagons, hexagons and octagons) and oval ring structures are possible groove shapes that can be used to create particular optical effects. Any shape that diffracts light in a uniform and isotropic manner may be advantageously employed. Groove depth, pitch, and refractive index of materials are also useful parameters for tuning color chromaticity and intensity of the structured color filtering image device.

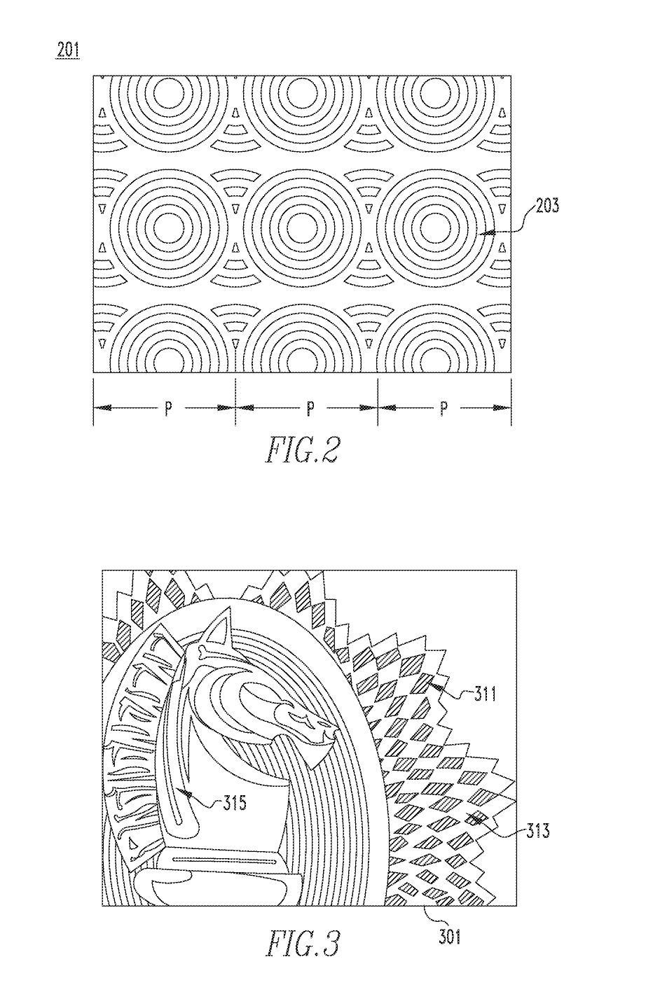

FIG. 2 shows an example filter device 201 made by repeating a unit cell 203 (such as the example unit cell illustrated in FIGS. 1A and 1B and having width P) across a surface in a linear rectangular array 207. By repeating unit cells, large areas of solid colors may be formed.

More interesting imagery can be formed by constructing a filter device comprising two or more areas, each having different colors or graphical effects. As previously disclosed, the color exhibited by a unit cell varies depending on the depth of the groove structure or the distance between reflective levels. A color filter comprising a first array of unit cells having a first depth disposed adjacent to a second array of unit cells having a second depth results in two adjacent areas exhibiting different colors. The step function groove pattern may be the same for both arrays, or different. Using different groove patterns for each color area will add additional optical effects.

Further, complex full-color imagery may be produced by forming individual pixels, each pixel comprising one or more unit cells of a uniform depth, where the pixels combine to form an image when viewed.

FIG. 3 illustrates a two-color image. Shown is an image 301 formed by constructing a filter device in accordance with an embodiment of the disclosed concept. The image 301 comprises interspersed areas of two-level unit cells having two different depths. For example, area 311 is filled by a plurality of unit cells having a first groove depth and area 313 is filled by a plurality of unit cells having a second groove depth. Because areas 311 and 313 were made at two different groove depths, when the image 301 is viewed, areas 311 and 313 appear in different colors.

In blocks of solid color or in thick lines, the unit cells sizes can be relatively large (for example, unit cells having a width of about 40 micrometers); however for fine lines, smaller unit cell sizes are preferred. Area 315 is comprised of smaller unit cells (for example, unit cells having a width of about 1.5 micrometers) giving greater flexibility for forming fine lines. Area 315 has the same structure depth as area 313 and therefore appears the same color as area 313. The finer structure created by the use of unit cells of small size allows the creation of graphical features resembling intaglio, gravure printing and metallic finish appearance, such as the horse in FIG. 3. The feature of the horse was made from a series of thin, curved contour lines of unit cells of small sizes; it thus exhibits fine graphical detail in the desired color. The ability to form such a wide range of graphical resolution, detail and effect makes the disclosed concept ideal not only for security applications, but for other specialty applications, such as decorative or artistic applications for example, as well.

It has been found that the brilliant specular reflection of a particular filtering device can be toned down by including a scattering effect into the structured profile itself, for example by varying randomly the groove side wall slope and/or width while still largely maintaining the fundamentally symmetric pattern. The introduction of such variations tends to make the observed color more matte in appearance, further reducing the harsh specular reflection.

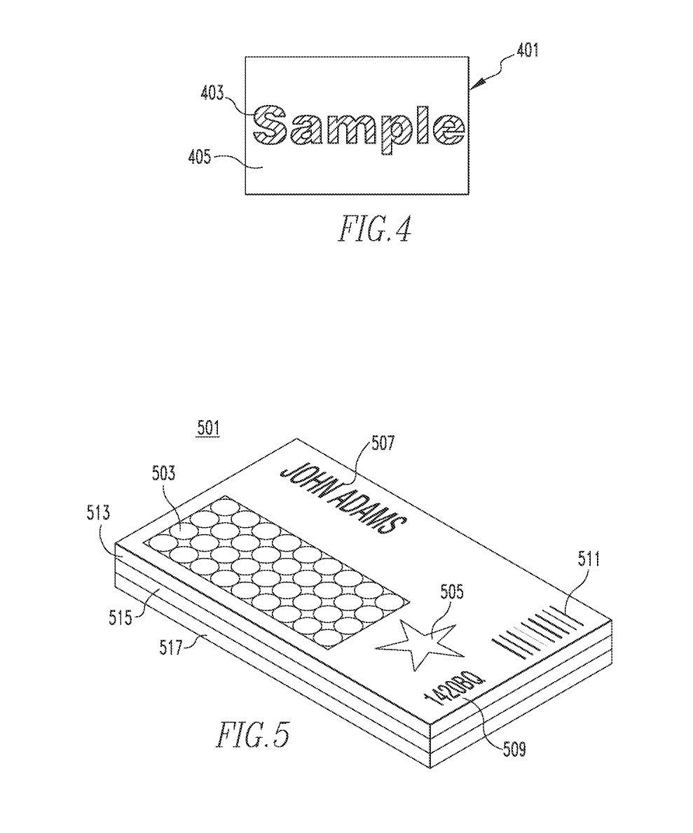

Sophisticated optical effects may also be created by combining the disclosed filtering device with one or more other OVDs in a composite pattern or image. A non-limiting example of an embodiment including such a combination is illustrated in FIG. 4, which shows a composite device 401 comprising a first color filter device 403 having a first arrangement of unit cells in a pattern representing alphanumeric characters (the word “Sample”), and an color shifting OVD 405 (e.g., without limitation, a color print or any other suitable OVD having a color shifting property) forming a background. With the appropriate colors, a composition such as the one shown in FIG. 4 may serve as a self-checking authentication tool. A viewer examining the composite device 401 at a first polar angle observes the expected color of the first color filter device (the word “Sample”) 403 against the different background color formed by the color shifting OVD 405. After tilting the composite device 401 to a second polar viewing angle, the viewer observes for a second time the expected color of the first color filter device 403 against the color formed by the color shifting OVD 405. For example, the colors exhibited by the first color filter device 403 and the color shifting OVD 405 may be different at the first polar angle of view, but the same at the second polar angle of view. In this case, the word “Sample” effectively disappears at the second angle of view. Alternatively, the word “Sample” may be hidden at the first angle of view and visible at the second polar angle of view, depending on the design of the composite device 401. In this example, the second color shifting OVD 405 may be any suitable OVD that exhibits a color shifting property or indeed even a non-OVD such as printed ink. The same color shift effect may be a security reinforcement of two very distinctive security components positioned next to each other for easy comparison. An authentication feature based on the comparison of one or more variable colors is known as a color comparison authentication tool. With such a tool, a synchronized shifting effect from two security elements made from two of the same or different devices provides easy and effective first-level inspection without the aid of any instrument.

The optical properties of the disclosed structured color filter make it ideal for use as a security device. By careful choice of colors, color ranges, and image design, a complex animated security image may be produced.

It will be appreciated by those skilled in the art that various modifications of, alternatives to and combinations of these embodiments can be developed in light of the overall teachings of the disclosure. Further, by combining these embodiments with other optical device technology known in the art, a full range of optical effects may be produced, allowing the formation of complex patterns and imagery that provide enhanced security and protection from copying and alteration.

The disclosed structured color filter device cannot be easily copied, and the optical effects of a bona fide device (as compared with an inexpensive lookalike) are instantly recognizable. Thus, once affixed to an article, the disclosed device can provide a simple and effective method for verifying the authenticity of the article.

Security devices comprising the disclosed device can take several forms, depending on the nature of the article the security device is designed to protect. For example, and without limitation, the security device may be produced as a label, a laminate, a thread, or a transfer film. Each of these final forms has an appropriate application on a particular type and configuration of an article.

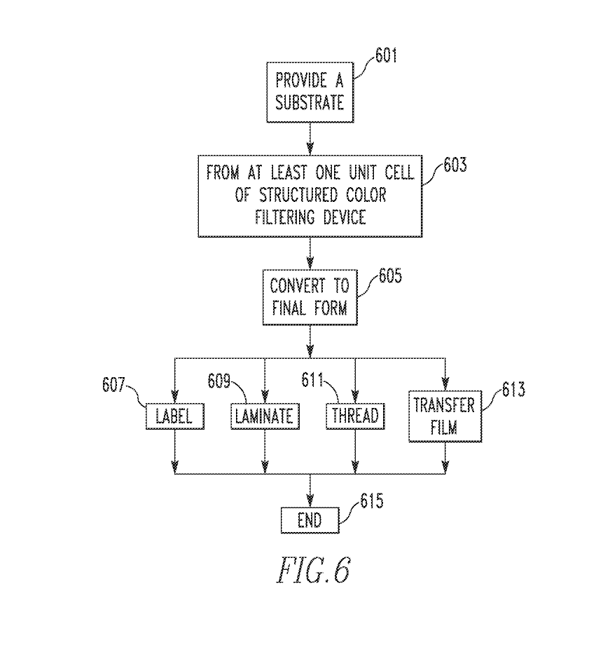

As a non-limiting example of a security device that uses the disclosed device, FIG. 5 shows a security device 501 produced as a self-adhesive label. The security device 501 comprises a structured color filter 503, a traditional hologram 505, identification text 507, a serial number 509 and a bar code 511, all disposed on a substrate 513. A layer of adhesive 515 and a release liner 517 are affixed to the bottom of the security device 501. To affix the security device 501 to an article to be authenticated, the release liner 517 is stripped away, exposing the adhesive layer 515, and the adhesive layer 515 is pressed against the article (not shown). For additional security, any of several anti-tampering features known in the art may be incorporated into the security device 501.

FIG. 6 is a flow diagram illustrating the steps of a method of making a security device in accordance with an embodiment of the disclosed concept. The method begins with the provision of a substrate at 601. The substrate can be any material into which a two- or multi-level step microstructure can be formed. Preferably, dielectric and metal substrates may be used, and more preferably a highly reflective polymeric resin substrate having a refractive index in the range of 1.3 to 1.7 may be used. Suitable materials include, for example and without limitation, plastic films made with polyethylene, polyimide, OPP, and PET resins. The reflectivity of the substrate may be enhanced by the application of a reflective coating, such as for example, a reflective metal, after the groove structures have been formed. Methods for the application of reflective coatings are various and are well-known in the art.

At step 603, at least one unit cell comprising a structured color filtering device according to an embodiment of this disclosure is formed into the surface of the substrate. The filtering device comprises a fundamentally symmetric pattern of a multi-level step function. The preferred cell size is from 1 to 200 micrometers; the preferred distance between reflective levels is from 100 to 2,000 nanometers, and the preferred groove pitch is from 0.5 to 10 micrometers.

The multi-level step function may be formed in a surface of the substrate by any of several methods known in the art for forming surface relief microstructures. For example and without limitation, the multi-level step function structure may be formed by coating a substrate with a photo-sensitive resin; optically recording a diffraction pattern or image into the resin; and processing the exposed photo-sensitive resin by chemical etching to form a surface relief pattern. The symmetric pattern may be recorded using an analog process such as a mask, or a digital process such as one using a scanning electron beam or laser device, for example. Other methods for creating a multi-level step function structure in a substrate include, for example and without limitation, direct embossing, molding, or direct chemical or laser etching.

Once formed, the multi-level step function relief structure may then be mass replicated by means known in the art. For example and without limitation, it may be mass replicated by first replicating the surface in nickel metal by means of electroforming. The nickel surface may then be used as a durable tool to replicate the multi-level step function structure in other substrates by means such as, for example and without limitation, embossing via heat and pressure, molding, casting, casting and cross-link curing, and other means.

The grooves may be left open to air, or they may be filled with a material having a different refractive index than the substrate. In practical terms, this means the structure depth can be designed for the refractive index of whatever material is desired to fill the grooves.

Security devices such as those contemplated by the present disclosure can take several forms, depending on the nature of the article the security device is designed to protect. For example, and without limitation, the security device may be produced as a label, a laminate, a thread, or a transfer film. The conversion of the structured color filtering device into a security device is shown at step 605. For clarity, each of the four converted forms of security devices discussed above is shown in separate optional steps. These forms are shown as examples only and do not represent all the forms of security devices that exist. The method, therefore, is not limited to only these four forms.

At 607, the structured color filter device is optionally converted into a security label. At 609, the structured color filter device is optionally converted into a security laminate. At 611, the structured color filter device is optionally converted into a security thread. At 613, the structured color filter device is optionally converted into a security transfer film. It will be appreciated that steps 607-613 may be omitted without departing from the scope of the disclosed concept. At 615 the method ends.

Each of these final security device forms has an appropriate application on a particular type and configuration of an article. For example, a label is created with the color filter device applied directly to it, with the label being subsequently affixed to an article in order to function as a security device or mechanism for authenticating the article. The construction of such a label is shown in FIG. 5, discussed above. Such labels are commonly employed on, for example, automobile license plates and inspection stickers to verify the registration and inspection status of the vehicle.

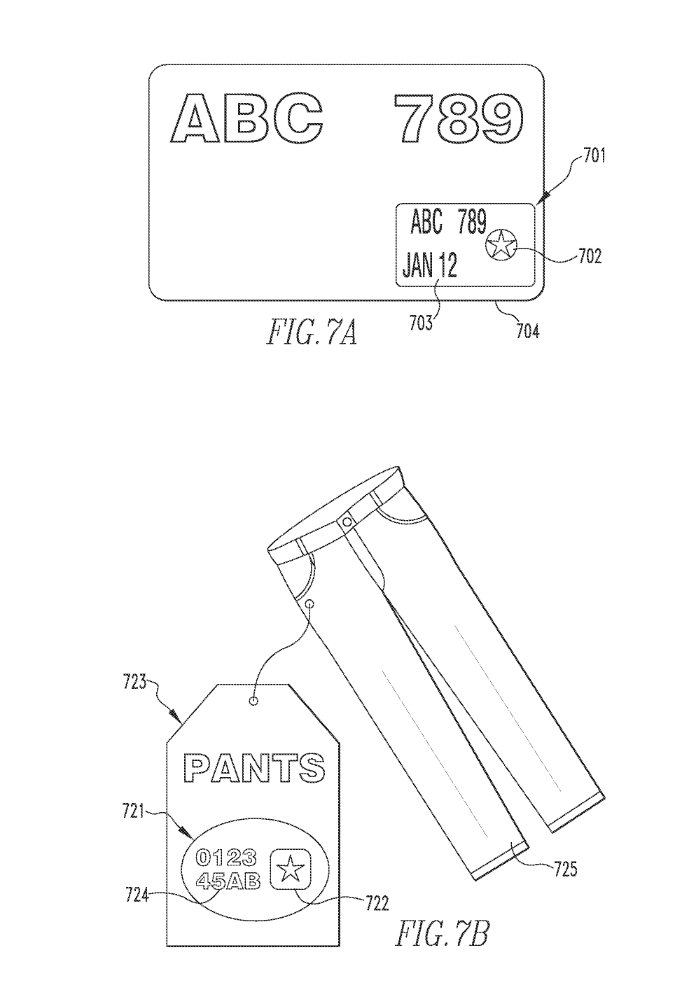

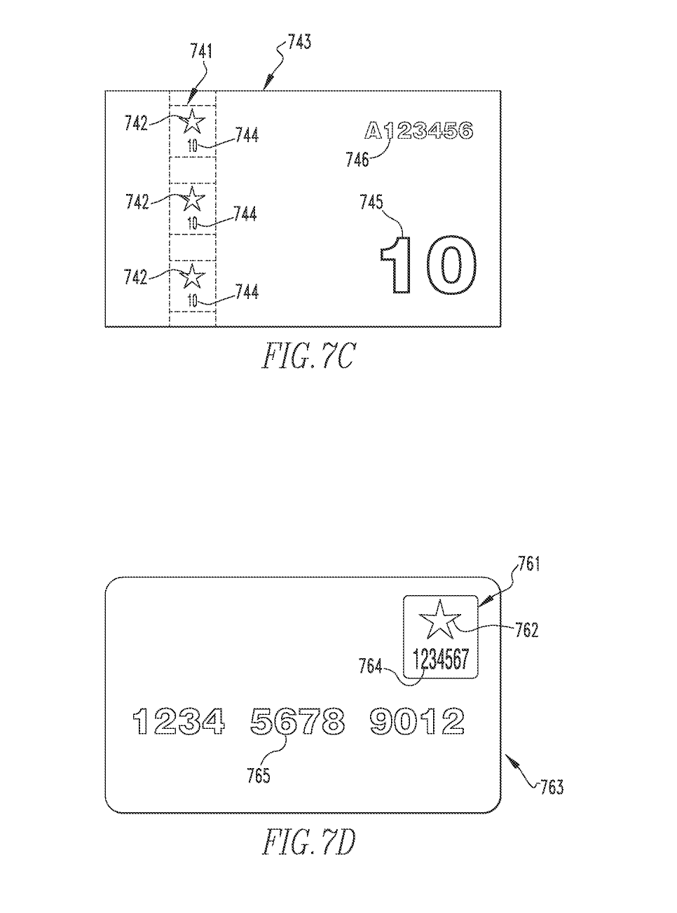

FIG. 7A shows another label 701 in accordance with an embodiment of the disclosed concept. The label 701 comprises a structured color filter device 702 made according to an embodiment of the disclosed concept. The label 701 is affixed to an article such as a license plate by means of an adhesive (not shown). The label 701 may also include additional information 703 in the form of characters, numbers or symbols. Such information may be fixed or variable unique information.

Laminates can be applied to a wide variety of articles, for example, as a coating or covering. For example, hang tags which are attached to goods to provide authentication of the goods, may include such laminates.

FIG. 7B illustrates the use of a laminate form of security device on a hang tag 723. The laminate security device 721 comprises a structured color filter device 722 made according to an embodiment of the disclosed concept. The laminate 721 is affixed to the hang tag 723 by means of an adhesive (not shown). The laminate 721 may include additional fixed or variable information 724. The hang tag 723 may be, for example, attached to a good 725 as a means for verifying the authenticity of the good 725.

Security thread is another delivery system which can be employed in conjunction with the disclosed color filter devices. The thread may be woven or slid into an article with which it will be employed as a security device. Thin articles, such as valuable paper articles, may contain color filter devices in thread form.

FIG. 7C illustrates the use of a security thread 741 in a banknote 743. The thread 741 comprises one or more structured color filter devices 742 made according to an embodiment of the disclosed concept. The thread 741 is incorporated into the paper stock of the banknote 743 during the paper's manufacture. The thread 741 may include additional fixed or variable information 744, which may match information printed on the banknote 747, such as the denomination 745 or a serial number 746.

Finally, transfer films comprise any type of film, such as, for example, foils, wherein a color filter device is applied by hot or cold stamping the foil, and subsequently transferring the foil from a substrate or carrier to the article. Transfer films comprising color filter devices may be used, for example, to affix security devices to transaction and identification cards.

Such a transfer film is illustrated in FIG. 7D, wherein the transfer film 761 comprises a structured color filter device 762 made according to an embodiment of the disclosed concept. The transfer film 761 is applied to an article 763 with the use of heat and pressure-sensitive adhesive (not shown). Once the heat and pressure are released, the substrate or carrier (not shown) is removed, leaving only the residual transfer film 761 affixed to the article 763. The transfer film 761 may comprise additional fixed or variable information 764, which may match information appearing on the article 763, such as an account number 765.

Whatever form the affixed or embedded security device takes, end-users of the article may verify the authenticity of the article by examining the structured color filtering device and confirming that the predetermined optical effects, pattern and/or image is present.

While specific embodiments of the structured color filter device have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A structured color filtering device comprising:
one or more unit cells, each unit cell comprising:
a substrate having a surface with a step function surface profile having two or more discrete levels formed therein, wherein the step function surface profile forms in the surface a plurality of grooves arranged in a fundamentally symmetric pattern having a periodic groove pitch,
wherein when ordinary light is incident on the surface, the surface is structured to diffract light having a predetermined wavelength toward observation points at all polar angles above the surface greater than a predetermined incident angle.

2. The structured color filtering device according to claim 1, wherein each unit cell includes outer edges that form a convex polygon.

3. The structured color filtering device according to claim 2, wherein apothems of the convex polygon are within a range of about 0.5 micrometers to about 100 micrometers.

4. The structured color filtering device according to claim 2, wherein the convex polygon is one of an equilateral triangle, a square and a regular hexagon.

5. The structured color filtering device according to claim 1, wherein a distance between two of the two or more discrete levels of the step function surface profile is within a range of about 100 nanometers to about 2,000 nanometers.

6. The structured color filtering device according to claim 1, wherein the periodic groove pitch is within a range of about 0.5 micrometers to about 10 micrometers.

7. The structured color filtering device according to claim 1, wherein each of the two or more discrete levels of the step function surface profile has a surface area, and wherein the surface areas of each of the two or more discrete levels of the step function surface profile are approximately equal.

8. The structured color filtering device according to claim 1, wherein two or more of the unit cells are arranged to form a tessellation.

9. The structured color filtering device according to claim 1, wherein the substrate is comprised of a dielectric material or a metal.

10. The structured color filtering device according to claim 1, wherein the one or more unit cells are first unit cells and the structured color filtering device further comprises:
one or more second unit cells, each unit second cell comprising:
a second substrate having a second surface with a second step function surface profile having two or more discrete levels formed therein, wherein the second step function surface profile forms in the second surface a plurality of second grooves arranged in a fundamentally symmetric pattern having a second periodic groove pitch,
wherein when ordinary light is incident on the second surface, the second surface is structured to diffract light having a second predetermined wavelength toward observation points at all polar angles above the second surface greater than a second predetermined incident angle.

11. The structured color filtering device according to claim 1, wherein the step function surface profile forms in the surface a secondary plurality of grooves arranged in a fundamentally symmetric pattern having a secondary periodic groove pitch, and wherein the secondary periodic groove pitch of the secondary plurality of grooves is substantially smaller than the periodic groove pitch of the plurality of grooves and/or a depth of the secondary plurality of grooves is substantially smaller than a depth of the plurality of grooves.

12. The structured color filtering device according to claim 1, wherein the grooves have sidewalls having randomly varying slopes and widths.

13. The structured color filtering device according to claim 1, wherein the one or more unit cells together form recognizable text, symbols or codes.

14. The structured color filtering device according to claim 1, further comprising:
a continuous or non-continuous reflective layer disposed upon the substrate.

15. The structured color filtering device according to claim 1, further comprising:
a material disposed in the grooves,
wherein a refractive index of the material disposed in the grooves is different than a refractive index of the substrate.

16. The structured color filtering device according to claim 1, wherein the substrate is transparent and has a first side and a second side opposite the first side, wherein the light having the predetermined wavelength is visible from observation points at all polar angles above the first side of the substrate greater than the predetermined incident angle, and wherein the light having the predetermined wavelength is visible from observation points at all polar angles above the second side of the substrate greater than the predetermined incident angle.

17. A security device comprising:
at least one structured color filtering device, the at least one structured color filtering device including:
one or more unit cells, each unit cell comprising:
a substrate having a surface with a step function surface profile having two or more discrete levels formed therein, wherein the step function surface profile forms in the surface a plurality of grooves arranged in a fundamentally symmetric pattern having a periodic groove pitch,
wherein when ordinary light is incident on the surface, the surface is structured to diffract light having a predetermined wavelength toward observation points at all polar angles above the surface greater than a predetermined incident angle.

18. The security device according to claim 17, further comprising:
a second structured color filtering device disposed adjacent to the at least one structured color filtering device, the second structured color filter device including:
one or more second unit cells, each second unit cell comprising:
a second substrate having a second surface with a second step function surface profile having two or more discrete levels formed therein, wherein the second step function surface profile forms in the second surface a plurality of second grooves arranged in a fundamentally symmetric pattern having a second periodic groove pitch,
wherein when ordinary light is incident on the second surface, the second surface is structured to diffract light having a second predetermined wavelength toward observation points at all polar angles above the second surface greater than a second predetermined incident angle.

19. The security device according to claim 17, further comprising:
a hologram device disposed adjacent to the at least one structured color filtering device.

20. The security device of claim 17, wherein the at least one structured color filtering device includes a plurality of structured color filtering devices, and where the plurality of structured color filtering devices together form at least one of a graphical image, a pattern and a design.

21. An article comprising:
a security device including at least one structured color filtering device, the at least one structured color filtering device including:
one or more unit cells, each unit cell comprising:
a substrate having a surface with a step function surface profile having two or more discrete levels formed therein, wherein the step function surface profile forms in the surface a plurality of grooves arranged in a fundamentally symmetric pattern having a periodic groove pitch,
wherein when ordinary light is incident on the surface, the surface is structured to diffract light having a predetermined wavelength toward observation points at all polar angles above the surface greater than a predetermined incident angle.

22. A method of creating a security device, the method comprising:
providing a substrate having a structured color filtering device disposed on a surface thereof, wherein the structured color filtering device comprises one or more unit cells, each unit cell having:
a substrate having a surface with a step function surface profile having two or more discrete levels formed therein, wherein the step function surface profile forms in the surface a plurality of grooves arranged in a fundamentally symmetric pattern having a periodic groove pitch,
wherein when ordinary light is incident on the surface, the surface is structured to diffract light having a predetermined wavelength toward observation points at all polar angles above the surface greater than a predetermined incident angle.

23. The method of claim 22, wherein each unit cell includes outer edges that form a convex polygon, and wherein apothems of the convex polygon are within a range of about 0.5 micrometers to about 100 micrometers.

24. The method of claim 22, wherein a distance between two of the two or more discrete levels of the step function surface profile is within a range of about 100 nanometers to about 2,000 nanometers.

25. The method of claim 22, wherein the periodic groove pitch is within a range of about 0.5 micrometers to about 10 micrometers.
